(19) United States
(12) Patent Application Publication
(10) Pub. No.: US 2009/0207988 A1
(43) Pub. Date: Aug. 20, 2009

(54) Method and system for telecommunication sessions using only initial signal messages

(75) Inventors: Richard E. Huber, Harmony, PA (US); Arun Punj, Cranberry Township, PA (US)

Correspondence Address: ERICSSON INC., 6300 LEGACY DRIVE, M/S EVR 1-C-11, PLANO, TX, 75024, US

(73) Assignee: Ericsson, Inc.

(21) Appl. No.: 12/070,261

(22) Filed: Feb. 15, 2008

(51) Int. Cl. H04M 3/56

(52) U.S. Cl. 379/202.01

(57) ABSTRACT

A telecommunications system includes a telecommunications network. The system includes n nodes, where n is an integer greater than or equal to 3, in communication with the network. The system includes a host node that creates a session through the network between the n nodes. The system includes an additional node in communication with the network, the host node adding the additional node to the session without any signaling messages being sent from the n nodes. A method for telecommunicating.

### FIELD OF THE INVENTION

The present invention is related to telecommunication sessions that eliminates the need to send additional signaling messages after initial signaling messages are sent between parties or nodes of the session. More specifically, the present invention is related to telecommunication sessions that eliminates the need to send additional signaling messages after initial signaling messages are sent between parties or nodes of the session, where the session can be multimedia conferencing or Instant Messaging.

### BACKGROUND OF THE INVENTION

Multimedia streams are normally signaled using standard protocols such as SIP or IMS. When a multimedia endpoint wishes to send media streams to another endpoint the initiating endpoint places the IP addresses, port number, codec type and other stream parameters into an ‘offer’ message and sends this to the recipient. If the recipient accepts this multimedia ‘call’ then it will generate a ‘reply’ message. This reply will contain the recipient's address, ports, and other parameters to match the stream parameters in offer message. When only two parties are involved in a ‘call’ this is known as a point-to-point (P2P) call.

When more than two parties wish to exchange multimedia streams there are two basic methods. The older less flexible method uses a P2P model to send and receive a single set of multimedia streams between an endpoint and a conference bridge or MCU. The 2^{nd} newer method eliminates the bridge or MCU requirement and uses a direct media stream to each party in the call. A very efficient way of streaming to many participants at once is to use multicast technology to minimize network bandwidth requirements. This multicast method is also known as point-to-multipoint (PMP) streaming.

### BRIEF SUMMARY OF THE INVENTION

The present invention pertains to a telecommunications system. The system comprises a telecommunications network. The system comprises n nodes, where n is an integer greater than or equal to 3, in communication with the network. The system comprises a host node that creates a session through the network between the n nodes. The system comprises an additional node in communication with the network, the host node adding the additional node to the session without any signaling messages being sent from the n nodes.

The present invention pertains to a method for telecommunicating. The method comprising the steps of forming a session between n parties were n is an integer greater than or equal to 3 thorough a telecommunications network. There is the step of adding an additional party to the session without sending any signaling messages from the n parties.

The present invention pertains to a method for telecommunicating. The method comprising the steps of conducting a session between a first party, a second party, a third party and a fourth party thorough a telecommunications network. There is the step of deleting the first party from the session by sending a bye signal to a host from the first party, sending only a disconnect of the first party to the second party from the host, sending only a disconnect of the first party to the third-party from the host, and sending only a disconnect of the first party to the fourth party from the host without any additional signals between the parties to delete the first party from the session.

The present invention pertains to a method for telecommunicating. The method comprising the steps of conducting a session between a first party, a second party, a third party and a fourth party thorough a telecommunications network. There is the step of changing session layout behavior of the first party by sending a behavior change event signal to a host from the first party, sending only a behavior change event of the first party to the second party from the host, sending only a behavior change event of the first party to the third-party from the host, and sending only a behavior change event of the first party to the fourth party from the host without any additional signals between the parties to change the first party from the session.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a representation of a telecommunications system of the present invention.

### DETAILED DESCRIPTION OF THE INVENTION

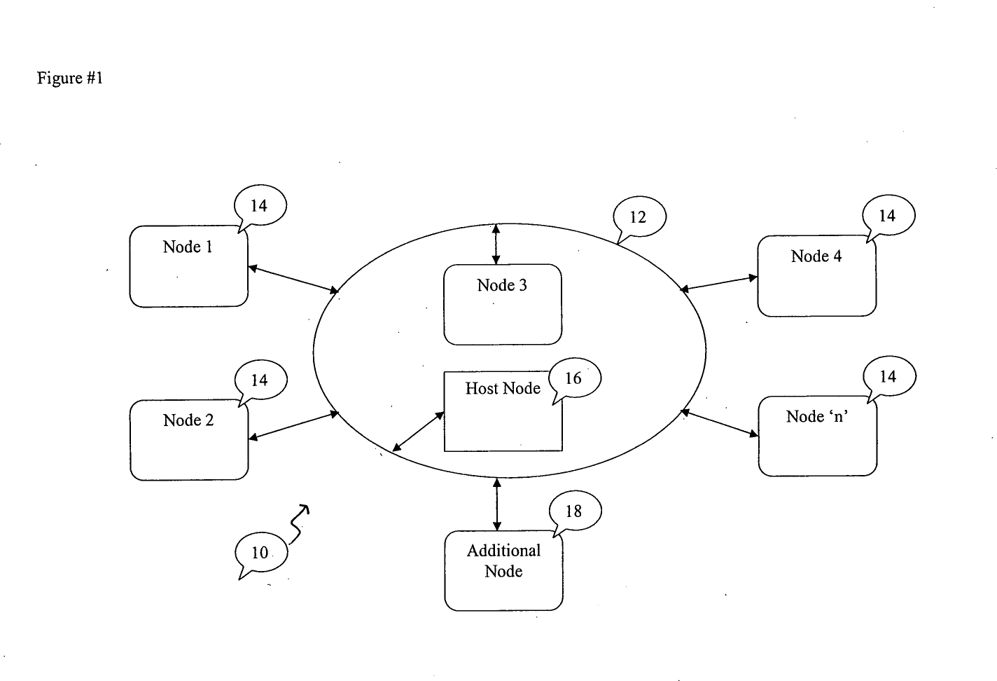

Referring now to the drawings wherein like reference numerals refer to similar or identical parts throughout the several views, and more specifically to FIG. 1 thereof, there is shown a telecommunications system 10. The system 10 comprises a telecommunications network 12. The system 10 comprises n nodes 14, where n is an integer greater than or equal to 3, in communication with the network 12. The system 10 comprises a host node 16 that creates a session through the network 12 between the n nodes 14. The system 10 comprises an additional node 18 in communication with the network 12, the host node 16 adding the additional node 18 to the session without any signaling messages being sent from the n nodes 14. Preferably, the host sends only (2 plus n) initial signaling messages with session layout behavior between the nodes 14 without any additional signaling messages between the nodes 14 to add the additional node 18 to the session. The nodes 14 preferably communicate with each other using PMP (point to multipoint) signaling, but are not limited thereto. The session preferably includes multimedia conferencing. Preferably, the host sends initial signaling messages having audio and video stream parameters to the parties. The additional party preferably sends its own audio and video stream parameters to the host. One example of a platform regarding multimedia conferencing as described herein is to use the ViPr consoles and associated network sold by Ericsson, Inc. The nodes 14 or parties can be computers, servers, videophones or audiophones.

Alternatively, the session can include IP Multimedia Subsystem (IMS) conferencing. The session can include instant messaging (IM).

The present invention pertains to a method for telecommunicating. The method comprising the steps of forming a session between n parties were n is an integer greater than or equal to 3 thorough a telecommunications network 12. There is the step of adding an additional party to the session without sending any signaling messages from the n parties.

Preferably, there is a host, and the adding step includes the step of sending the initial signaling messages from the host to the parties using PMP (point to multipoint) signaling. The adding step preferably includes the step of sending only (2 plus n) initial signaling messages with session layout behavior between the parties without any additional signaling messages between the parties to add the additional party to the session. Preferably, the sending step includes the step of the host sending initial signaling messages having audio and video stream parameters to the parties.

The adding step preferably includes the step of the additional party sending its own audio and video stream parameters to the host. Preferably, there is the step of creating per stream inclusion in sets by each party containing desired participants in each set. There is preferably the step of creating an exclusion set by each party to prevent inclusion of certain streams to the respective party. Preferably, there is the step of forming dynamic sets using logical intersections or unions of multiple sets. The conducting step preferably includes the step of conducting a multimedia conference.

The conducting step can include the step of conducting an IP Multimedia Subsystem (IMS) conference. The conducting step can include the step of conducting instant messaging (IM).

The present invention pertains to a method for telecommunicating. The method comprising the steps of conducting a session between a first party, a second party, a third party and a fourth party thorough a telecommunications network 12. There is the step of deleting the first party from the session by sending a bye signal to a host from the first party, sending only a disconnect of the first party to the second party from the host, sending only a disconnect of the first party to the third-party from the host, and sending only a disconnect of the first party to the fourth party from the host without any additional signals between the parties to delete the first party from the session.

The present invention pertains to a method for telecommunicating. The method comprising the steps of conducting a session between a first party, a second party, a third party and a fourth party thorough a telecommunications network 12. There is the step of changing session layout behavior of the first party by sending a behavior change event signal to a host from the first party, sending only a behavior change event of the first party to the second party from the host, sending only a behavior change event of the first party to the third-party from the host, and sending only a behavior change event of the first party to the fourth party from the host without any additional signals between the parties to change the first party from the session.

Preferably, no conferencing bridge or MCU is used in the network 12 for the parties or nodes 14 to communicate with each other. Instead, direct streams are sent between the parties, such as by using multicasting, also know as point to multipoint (PMP) streaming.

In the operation of the invention, to use PMP streaming each endpoint must exchange the lists of addresses, ports, codecs, and other parameters between each endpoint that is participating in the call. The necessity of each endpoint to communicate with each other endpoint directly would require a full mesh of signaling channels and would also require sending the same PMP media information to every endpoint. A simple way to reduce the number of signaling channels and signaling messages is to have one endpoint also become the conference signaling ‘host’. Each party only needs to tell the conference host its PMP information once and then the ‘host’ can send all of the PMP information to each of the endpoints only once.

A rich collaborative multimedia application can offer each user the ability to choose which audio and video streams to view or subscribe. This means that every available media stream will NOT necessarily be sent to each party. To make this possible, each endpoint must provide a per multimedia stream list that states which particular streams are to be subscribed to. This provides a very flexible conferencing architecture, however this flexibility comes at the cost of signaling complexity.

As an example consider when a new party ‘D’ is invited into an existing ‘call’ with ‘A’, ‘B’ and ‘C’. The following five signaling messages are sent:
‘Host’ sends audio and video stream parameters of A, B, and C to ‘D’
‘D’ sends it's own audio and video stream parameters to ‘Host’
Host sends ‘D’ parameters to ‘A’
Host sends ‘D’ parameters to ‘B’
Host sends ‘D’ parameters to ‘C’

Notice that the addition of a participant required 5 initial signaling messages. The actual number of initial signaling messages can be generalized to be (2+N) messages, where N is the number of existing participants in the call.

All of the parties in this call now have all of the information of all available streams. The final step is to send back the list of subscribed streams to the conference ‘host’ so that the host can relay these lists to the appropriate parties. The following messages need to be sent to complete the new party addition:
‘A’ sends to ‘Host’ the new list of streams to receive (including ‘D’)
Host sends to ‘D’ the stream list from ‘A’
‘B’ sends to ‘Host’ the new list of streams to receive (including ‘D’)
Host sends to ‘D’ the stream list from ‘B’
‘C’ sends to ‘Host’ the new list of streams to receive (including ‘D’)
Host sends to ‘D’ the stream list from ‘C’

So as seen above, the participant addition also required a secondary group of (6) signaling messages to be sent. The number of secondary messages can be calculated as (2*N), where once again ‘N’ is the number of existing participants.

When the number of conference participants ‘N’ is large enough it may require that other received media streams be removed when a new media stream is added. The conference ‘Host’ will need to send an updated media stream list to all endpoints which were providing the now dropped streams. The number ‘E’ of ‘extra’ secondary signaling messages will vary depending on screen layouts and user preferences.

So, the total number of signaling messages to add a new participant is 2+(3*N)+E. The primary purpose of this invention is to eliminate all of the secondary messages that are currently required when adding a new participant.

The saving of at least (6) extra messages for even a 3 party call may not seem like much. However, when these (6) messages are routed through a typical IMS network 12, these same messages could easily traverse 3 or 4 IMS CSCF Proxies. There is also a minimum of one reply message for each of these outgoing signaling messages. This means that the real number of signaling messages would be (6×2)×4, or 48 extra signaling messages.

When this is factored into a large IMS network 12 where many simultaneous calls are active at once, the number of extra messages is easily in the thousands. This can be a significant savings when calculating IMS server capacity, since the server does not need to be provisioned to handle the load from these extra messages.

One of the ways to eliminate the extra secondary signaling messages is to impart some of the knowledge of the default behavior of adding a party, into the conference host and/or into the other participant endpoints. First, the conference layout behavior that a participant chooses could be made available in the initial signaling messages. Then each participant could use this information to know in advance which streams are to be received.

Typically, an endpoint has a list of participant audio streams for listening, and a list of video participants to view. The video streams can be further divided into at least two categories. First, the participants that use high resolution video streams, and next the participants that are displayed using low resolution video ‘thumbnails’. These lists of audio and video streams can also be thought of as media stream ‘sets’. This would consist of an Audio ‘set’, a High-Res Video ‘set’ and a Low-Res Video ‘set’. The members or elements of these ‘sets’ are the conference participants or a unique identifier representing them. If a participant is a member of a particular media stream ‘set’ than that media stream of that participant is to be received.

Guided by conference layout behaviors and user preferences an endpoint creates per stream inclusion ‘sets’ containing the desired participants to be included in each set. It is also possible to create an explicit ‘exclusion set’ to prevent the inclusion of certain streams. But, one of the more useful ‘sets’ is a set that is ‘dynamically’ created using logical intersections or unions of multiple sets. For example, a ‘dynamic’ set can be formed using conference layout rules that state that the current ‘Audio’ set is the logical union of the Low-Res set and the High-Res set. Another ‘dynamic’ set could be formed by defining the Low-Res set as all conference participants NOT included in the High-Res set. Certain constraints can also be applied to further limit the media stream sets. These constraints can be user specified, such as a layout preference of two high resolution videos displayed side by side. Or, a system constraint can be used which limits the number of displayed Low-Res videos to be eight.

Even though these ‘dynamic’ sets can be different for each endpoint, they were formed using layout rules with some additional user and system 10 constraints. If these layout rules and constraints were communicated to each other participant then each endpoint could build the ‘dynamic’ set for every other endpoint. If every other endpoint knows an endpoint's stream selections, then that endpoint does not need to send a stream selection update message to other endpoints.

The initial layout rules and constraints would be included in the initial media parameters so that no extra signaling messages are required. The only time that a new signaling message would be required is when the layout and/or constraints change.

Since the host is relaying the set and layout information, the host ‘can’ also save the sets and use them to further optimize the signaling. The host can know exactly which nodes 14 are listening to a stream sent from another node based on the sets. If the sending node were to send a media format change message, then the host can use the set information to only relay those changes to the nodes 14 who are actually listening. If the host did not have the sets, then it would need to send media format messages to all other nodes 14.

The above showed the signaling messages required to add a new party to the call. The following examples show some other conference call operations (Call currently has 4 participants A, B, C & D)

1) Deleting a participant from the call
Party ‘D’ issues a BYE to the ‘Host’
Host sends ‘disconnect’ event to ‘A’
Host sends ‘disconnect’ event to ‘B’
Host sends ‘disconnect’ event to ‘C’
The following secondary signaling messages would NOT be sent when using Dynamic Sets (A savings of 9 signaling messages):
   Party ‘A’ sends new media stream receive list to ‘Host’
   ‘Host’ sends to ‘C’ the updated media stream lists for ‘A’
   ‘Host’ sends to ‘D’ the updated media stream lists for ‘A’
   Party ‘B’ sends new media stream receive list to ‘Host’
   ‘Host’ sends to ‘A’ the updated media stream lists for ‘B’
   ‘Host’ sends to ‘c’ the updated media stream lists for ‘B’
   Party ‘C’ sends new media stream receive list to ‘Host’
   ‘Host’ sends to ‘A’ the updated media stream lists for ‘C’
   ‘Host’ sends to ‘D’ the updated media stream lists for ‘C’

2) A participant changes their screen layout from a display of ‘3-Up’ to ‘2-Up’:
Party ‘D’ issues a ‘layout change’ event to ‘Host’
Host sends ‘layout change’ event to ‘A’
Host sends ‘layout change’ event to ‘B’
Host sends ‘layout change’ event to ‘C’
The following secondary signaling messages would NOT be sent when using Dynamic Sets(A savings of 16 signaling messages):
   Party ‘A’ sends new media stream receive list to ‘Host’
   ‘Host’ sends to ‘B’ the updated media stream lists for ‘A’
   ‘Host’ sends to ‘C’ the updated media stream lists for ‘A’
   ‘Host’ sends to ‘D’ the updated media stream lists for ‘A’
   Party ‘B’ sends new media stream receive list to ‘Host’
   ‘Host’ sends to ‘A’ the updated media stream lists for ‘B’\
   ‘Host’ sends to ‘C’ the updated media stream lists for ‘B’
   ‘Host’ sends to ‘D’ the updated media stream lists for ‘B’
   Party ‘C’ sends new media stream receive list to ‘Host’
   ‘Host’ sends to ‘A’ the updated media stream lists for ‘C’
   ‘Host’ sends to ‘B’ the updated media stream lists for ‘C’
   ‘Host’ sends to ‘D’ the updated media stream lists for ‘C’
   Party ‘D’ sends new media stream receive list to ‘Host’
   ‘Host’ sends to ‘A’ the updated media stream lists for ‘D’
   ‘Host’ sends to ‘B’ the updated media stream lists for ‘D’
   ‘Host’ sends to ‘C’ the updated media stream lists for ‘D’

The following is the basis for practicing the above.

The “Session Initiation Protocol” (SIP) is described in the IETF RFC-3261, incorporated by reference herein. This is the underlying protocol used in almost all of the worlds “Voice Over Internet Protocol”, or VoIP phones. This protocol was designed to completely replace the old PSTN phone system with an easily extensible framework that used the vast Internet network 12 as the phone network 12. SIP forms the signaling framework that carries all of the signaling messages used in a call. However, to enable the easy development of new services, RFC-3261 does NOT define exactly what is contained within these signaling messages. To enable interoperability between various SIP devices RFC-3264, incorporated by reference herein, was developed at the same time as RFC-3261. RFC-3264 is titled “An Offer/Answer model with SDP”. The most popular ‘payload’ carried within the SIP framework is the “Session Description Protocol” (SDP) which is defined in RFC-4566, incorporated by reference herein. These 3 RFC's (RFC-3261, RFC-3264, and RFC-4566) form the signaling basis for nearly every VoIP phone and many conferencing and phone systems. Although the SDP messages contain network 12 information about the media streams, they do NOT carry the actual audio and video streams themselves. The media streams are transported using the “Real Time transport Protocol” or RTP, which is defined in RFC-3550.

To define the ‘sets’ and ‘layout behaviors’, a few proprietary attributes are added to the SDP message that is used here. The SDP standard documents how to properly format proprietary attributes using an “a=X-” prefix. The following examples show how the extensions described here are applied to SDP. The first example is an explicit ‘inclusion set’ that contains a list of participants that have media streams that would be received. The format of this attribute could be “a=X-RxPartyList: 3 5”. This would be interpreted to mean that this participant is interested in receiving media streams from Participant #3 and Participant #5. The 2nd example is of a ‘dynamic set’ formed from the intersection of ‘All Participants’ and an explicit ‘exclusion’ list. The format of this attribute could be “a=X-RxExcludeList: 3 5”. The actual ‘set’ of participants varies depending on how many other participants are present in this conference session. If this conference now has six total participants numbered ‘1’ through ‘6’ then the set of all participants is defined as “1 2 3 4 5 6”. If the set “3 5” is treated as an exclusion set, then this ‘dynamic’ set is equal to “1 2 4 6”, since parties ‘3’ and ‘5’ have been excluded. Since this set is ‘dynamic’, if participants ‘7’ and ‘8’ join and participant ‘4’ disconnects, the new set would be “1 2 6 7 8”. The important thing to note is that although participants have been added and deleted, no participant needs to send any signaling messages updating their own receive subscription lists, since the other parties just use the dynamic set. The last example is an attribute “a=X-ConfLayout:2-UpWide”. This attribute is used to indicate the number of large video windows that a particular participant will be using for their screen layout. This could be used in combination with other participant ‘sets’ to form a dynamic ‘set’ that changes based on screen layout. A complete SDP message containing the extensions described here could look like:
v=0
o=name 0 0 IN IP4 192.168.10.10
s=session
i=-
c=IN IP4 192.168.10.10
t=0 0
a=X-ConfLayout:2-UpWide
m=audio 49170 RTP/AVP 0
m=audio 49170 RTP/AVP 34
a=X-RxPartyList: 3 5
m=video 49170 RTP/AVP 31
a=X-RxExcludeList: 3 5

Using ‘sets’ for Instant Messaging (IM) applications:

Examples of inclusion ‘sets’, would be a named buddy list, such as ‘Family’ or ‘Co-workers’. Some examples of exclusion sets would be a ‘Blocked’ or maybe a ‘Rude People’ list.

Here are some examples of simple dynamic sets:

1. Contacts within a geographic area

2. Contacts who can display video

3. Contacts who have audio

4. Contacts within a buddy list

5. Contacts that have their presence shown as ‘On Line’

The dynamic sets can then be used to control which contacts will get your audio and which will get your video or any other multimedia stream. Of course the real power comes from logical combinations of sets and the rules that build logical dynamic sets. An IM protocol such as XMPP could be extended to carry these rules, where XMPP is the “Extensible Messaging and Presence Protocol” and is defined in IETF RFC-3920, incorporated by reference herein. For example, a dynamic set named ‘Contacts that can view my video’, could be defined as contacts in my ‘Friends’ buddy list (set) AND who are in the ‘Have Video capability’ set AND are NOT in my ‘Bad Hair Day’ list.

The IM server could use the sets, rules, and capabilities to build the dynamic ‘sets’ without secondary signaling from the IM clients.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A method for telecommunicating comprising the steps of:
forming a session between n parties were n is an integer greater than or equal to 3 thorough a telecommunications network; and
adding an additional party to the session without sending any signaling messages from the n parties.

2. A method as described in claim 1 including a host, and the adding step includes the step of sending the initial signaling messages from the host to the parties.

3. A method as described in claim 2 wherein the adding step includes the step of sending only (2 plus n) initial signaling messages with session layout behavior between the parties without any additional signaling messages between the parties to add the additional party to the session.

4. A method as described in claim 3 wherein the sending step includes the step of the host sending initial signaling messages having audio and video stream parameters to the parties.

5. A method as described in claim 4 wherein the adding step includes the step of the additional party sending its own audio and video stream parameters to the host.

6. A method as described in claim 5 including the step of creating per stream inclusion in sets by each party containing desired participants in each set.

7. A method as described in claim 6 including the step of creating an exclusion set by each party to prevent inclusion of certain streams to the respective party.

8. A method as described in claim 7 including the step of forming dynamic sets using logical intersections or unions of multiple sets.

9. A method as described in claim 8 wherein the conducting step includes the step of conducting a multimedia conference.

10. A method as described in claim 8 wherein the conducting step includes the step of conducting an IP Multimedia Subsystem (IMS) conference.

11. A method as described in claim 3 wherein the conducting step includes the step of conducting instant messaging (IM).

12. A method as described in claim 3 wherein the sending step includes the step of sending the initial signaling messages from the host to the parties using a PMP signaling protocol.

13. A method for conferencing comprising the steps of:
conducting a session between a first party, a second party, a third party and a fourth party thorough a telecommunications network; and
deleting the first party from the session by sending a bye signal to a host from the first party, sending only a disconnect of the first party to the second party from the host, sending only a disconnect of the first party to the third-party from the host, and sending only a disconnect of the first party to the fourth party from the host without any additional signals between the parties to delete the first party from the session.

14. A method for conferencing comprising the steps of:
conducting a session between a first party, a second party, a third party and a fourth party thorough a telecommunications network; and
changing session layout behavior of the first party by sending a behavior change event signal to a host from the first party, sending only a behavior change event of the first party to the second party from the host, sending only a behavior change event of the first party to the third-party from the host, and sending only a behavior change event of the first party to the fourth party from the host without any additional signals between the parties to change the first party from the session.

15. A telecommunications system comprising:
a telecommunications network;
n nodes, where n is an integer greater than or equal to 3, in communication with the network;
a host node that creates a session through the network between the n nodes; and
an additional node in communication with the network, the host node adding the additional node to the session without any signaling messages being sent from the n nodes.

16. A system as described in claim 15 wherein the host sends only (2 plus n) initial signaling messages with session layout behavior between the nodes without any additional signaling messages between the nodes to add the additional node to the session.

17. A system as described in claim 16 wherein the session includes multimedia conferencing.

18. A system as described in claim 17 wherein the host sends initial signaling messages having audio and video stream parameters to the parties.

19. A system as described in claim 18 wherein the additional party sends its own audio and video stream parameters to the host.

20. A system as described in claim 16 wherein the session includes IP Multimedia Subsystem (IMS) conferencing.

21. A system as described in claim 16 wherein the session includes instant messaging (IM).

22. A system as described in claim 16 wherein the node uses a PMP signaling protocol for sending the initial signaling messages.
